(19) United States
(12) Patent Application Publication
(10) Pub. No.: US 2014/0281991 A1
(43) Pub. Date: Sep. 18, 2014

(54) USER INTERFACE, CONTROL SYSTEM, AND OPERATION METHOD OF CONTROL SYSTEM

(71) Applicant: AVERMEDIA TECHNOLOGIES, INC., NEW TAIPEI CITY (TW)

(72) Inventors: Chia-Chen CHAO, TAIPEI HSIEN (TW); Shou-Kuo TAI, TAIPEI HSIEN (TW); Wen-Chi YEN, TAIPEI HSIEN (TW); Pei-Ling HSU, TAIPEI HSIEN (TW); Ya-Ling HSU, TAIPEI HSIEN (TW); Chun-Tang HSU, TAIPEI HSIEN (TW)

(73) Assignee: AVERMEDIA TECHNOLOGIES, INC., NEW TAIPEI CITY (TW)

(21) Appl. No.: 13/845,134

(22) Filed: Mar. 18, 2013

(51) Int. Cl. G06F 3/0482

(52) U.S. Cl. CPC G06F 3/0482
USPC 715/719

(57) ABSTRACT

A user interface is displayed in a handheld device, and is used to control an electronic device electrically connected to the handheld device. The user interface includes at least one function selection region, an execution region, and a display region. The execution region is surrounded by the function selection region, and is electrically connected to the function selection region. The execution region is used to execute a function of the function selection region, and is used to send a comment corresponding to the execution region to the electronic device. When the function selection region is selected, the display region displays first information corresponding to the function selection region. When the execution region is pressed, the display region displays second information fed back from the electronic device to the handheld device in accordance with the comment.

### BACKGROUND

1. Field of Invention

The present invention relates to a user interface, a control system and an operation method of the control system.

2. Description of Related Art

A physical remote controller attached to a conventional video capture device is mostly a traditional directional remote controller. A remote controller is often provided with a plurality of complex function buttons or setting buttons which are difficult to identity if no words are marked adjacent to the buttons for reference. That is to say, a user is not very experienced when using the remote controller for the first time, and the press buttons set with similar sizes may easily cause an error press condition for an older user or a user with poor eyesight. For improvement of performance and quality of a game, a remote controller designed with a too complex interface is not suitable for a game player. For example, if such a remote controller is used, when playing a game through a joystick by using both hands, the game player has to see the video recording press button and then press the same through a hand, which is inconvenient for the user to use and affects the quality of game playing.

Furthermore, desired information related to the video capture device, such as a used video recording time and a rest hard disk space, cannot be acquired by the user from a display and a remote controller connected and attached to the conventional video capture device, and one remote controller should be provided additionally in sales of one video capture device, which causes a cost remained high.

### SUMMARY

An aspect of the present invention provides a user interface. The user interface is displayed in a handheld device, and is used to control an electronic device electrically connected to the handheld device.

According to an embodiment of the present invention, a user interface includes at least one function selection region, an execution region and a display region. The execution region is surrounded by the function selection region. The execution region is used to execute a function of the function selection region, and is used to send a comment corresponding to the execution region to the electronic device. When the function selection region is selected, the display region is used to display first information of the electronic device corresponding to the function selection region. When the execution region is pressed, the display region is used to display second information fed back from the electronic device to the handheld device in accordance with the comment.

In an embodiment of the present invention, the number of the function selection regions is plural. The user interface further includes a positioning mark. The positioning mark is disposed at an inner edge or outer edge of the function selection regions.

In an embodiment of the present invention, an outer edge of the execution region is adjacent to an inner edge of the function selection region.

In an embodiment of the present invention, the function selection region is a video recording selection button, a network streaming selection button, a video play selection button, a video capture selection button or a setting selection button.

In an embodiment of the present invention, the number of the function selection regions is plural, and when one of the function selection regions is selected, the selected function selection region, the execution region and the display region display a first background color. When another one of the function selection regions is selected, the selected function selection region, the execution region and the display region display a second background color different from the first background color.

Another aspect of the present invention provides a control system.

According to an embodiment of the present invention, a control system includes an electronic device and a handheld device. The handheld device is electrically connected to the electronic device. The handheld device has a user interface, and the user interface includes at least one function selection region, an execution region and a display region. The execution region is surrounded by the function selection region. The execution region is used to execute a function of the function selection regions, and is used to send a comment corresponding to the execution region to the electronic device. When the function selection region is selected, the display region is used to display first information of the electronic device corresponding to the function selection region. When the execution region is pressed, the display region is used to display second information fed back from the electronic device to the handheld device in accordance with the comment.

In an embodiment of the present invention, the electronic device includes a video recording unit, a network stream unit, a video display unit, a video capture unit or combinations thereof.

Another aspect of the present invention provides an operation method of a control system.

According to an embodiment of the present invention, the operation method of the control system includes the following steps: (a) providing a handheld device having a user interface and an electronic device electrically connected to the handheld device; (b) selecting at least one function selection region of the user interface, such that a display region of the handheld device displays first information of the electronic device corresponding to the function selection regions; (c) pressing an execution region of the user interface, wherein the execution region is surrounded by the function selection region; (d) sending a comment corresponding to the execution region to the electronic device, and feeding back second information from the electronic device to the handheld device in accordance with the comment; and (e) displaying the second information in the display region.

In an embodiment of the present invention, the step (b) includes pressing the function selection region of the user interface, such that the function selection region is selected.

In an embodiment of the present invention, the number of the function selection regions is plural, and the step (b) includes: dragging the function selection regions towards a direction, such that the function selection regions rotate around the execution region; and stopping dragging the function selection regions, such that one of the function selection regions aligned to a positioning mark is selected.

In the aforesaid embodiments of the present invention, since the user interface displayed in the handheld device includes no other press buttons except the function selection region and the execution region, and the execution region is surrounded by the function selection region, the operation interface is designed very terse to enable a user to operate the user interface intuitively.

Furthermore, since the user interface is displayed in the handheld device and the handheld device is electrically connected to the electronic device, the handheld device can send a comment to the electronic device through the user interface, and the electronic device can feed back information to the handheld device in accordance with the comment. After the handheld device receives the information from the electronic device, the display region of the handheld device displays information of the electronic device corresponding to the execution region. As a result, the information displayed in the display region of the user interface can be updated synchronously with that of the electronic device for convenience of monitoring by the user interface.

Additionally, the user interface can be displayed on a screen of the handheld device, and the handheld device may for example be a cell phone or a tablet computer, so that it does not require that the electronic device should be provided with a conventional remote controller corresponding to the electronic device during product shipping. It only requires providing an optical disk or network download point of the user interface to be stored into the handheld device by the user, such that the handheld device can control the electronic device through the user interface. Therefore, the manufacture cost of the conventional remote controller can be eliminated.

### BRIEF DESCRIPTION OF THE DRAWINGS

FIG. 1 is a block diagram of a control system according to an embodiment of the present invention;

FIG. 2 is a front view of a user interface displayed in a handheld device according to an embodiment of the present invention;

FIG. 3 is a front view of the execution region shown in FIG. 2 after being pressed;

FIG. 4 is a front view of the function selection region shown in FIG. 2 after being dragged towards a direction;

FIG. 5 is a front view of the function selection region shown in FIG. 4 after being dragged towards the direction;

FIG. 6 is a front view of the function selection region shown in FIG. 5 after being dragged towards the direction;

FIG. 7 is a front view of a user interface displayed in a handheld device according to another embodiment of the present invention;

FIG. 8 is a front view of the function selection region shown in FIG. 7 after being dragged towards a direction;

FIG. 9 is a front view of the function selection region shown in FIG. 8 after being dragged towards the direction;

FIG. 10 is a front view of the function selection region shown in FIG. 9 after being dragged towards the direction; and

FIG. 11 is a flow chart of an operation method of a control system according to an embodiment of the present invention.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawings.

FIG. 1 is a block diagram of a control system 10 according to an embodiment of the present invention. As shown in the figure, the control system 10 includes a handheld device 100 and an electronic device 200. The handheld device 100 may be electrically connected to the electronic device 200 through a wired or wireless method. For example, the handheld device 100 can be connected to the electronic device 200 through a local network point-to-point connection, a bluetooth connection or an infrared connection. In this embodiment, the handheld device 100 may be a smart phone, and is used to store a user interface (will be described hereinafter) used for controlling the electronic device 200. However, in other embodiments, the handheld device 100 may alternatively be a tablet computer or a notebook computer. The electronic device 200 may be a video capture device including a video recording unit, a network stream unit, a video display unit and a video capture unit, which has functions of video recording, network streaming, video displaying and video capturing. However, the electronic device 200 is not limited to the video capture device. Furthermore, the electronic device 200 can be electrically connected to a display 300 and a gaming device 400, so that the gaming image of the gaming device 400 can be displayed in the display 300 through the electronic device 200.

FIG. 2 is a front view of a user interface 115 displayed in the handheld device 100 according to an embodiment of the present invention. Referring to both of FIGS. 1 and 2, the handheld device 100 stores the user interface 115, and the user interface 115 can be displayed on the screen of the handheld device 100. The user interface 115 includes function selection regions 110a, 110b, 110c and 110d, an execution region 120 and a display region 130. The execution region 120 is surrounded by the function selection regions 110a, 110b, 110c and 110d. In this embodiment, the shape of the execution region 120 may be a round shape; the entire shape of the function selection regions 110a, 110b, 110c and 110d may be a ring shape; and the outer edge of the execution region 120 is adjacent to the inner edge of the function selection regions 110a, 110b, 110c and 110d. However, in other embodiments, the shape of the execution region 120 and the entire shape of the function selection regions 110a, 110b, 110c and 110d may be other shapes except the aforesaid shapes. For example, the shape of the execution region 120 may be a square or rectangle shape, and the entire shape of the function selection regions 110a, 110b, 110c and 110d may be a mouth shape.

When one of the function selection regions 110a, 110b, 110c and 110d is selected, the display region 130 can display first information of the electronic device 200 corresponding to the selected function selection region. In this embodiment, the function selection regions 110a, 110b, 110c and 110d respectively are a video recording selection button, a video play selection button, a setting selection button and a video capture selection button. However the number and function of the function selection region is determined in accordance with the function of the electronic device 200, and the number and function thereof described above are not intended to limit the present invention. One of the function selection regions 110a, 110b, 110c and 110d can be selected as being pressed. For example, when the function selection region 110a is pressed the display region 130 displays first information related to video recording (e.g. the rest available time for video recording) sending from the electronic device 200. The first information may be transmitted to the handheld device 100 by the electronic device 200.

Furthermore, the user interface 115 may further include a positioning mark 140. The positioning mark 140 may be located at the outer edge (as shown in FIG. 2) or inner edge of the function selection regions 110a, 110b, 110c and 110d. When any one of the function selection regions 110a, 110b, 110c and 110d is dragged towards a direction D1 (e.g., a clockwise direction), the function selection regions 110a, 110b, 110c and 110d can be rotated around the execution region 120 in the direction D1. When the function selection regions 110a, 110b, 110c and 110d are stopped to drag, the function selection region 110a aligned to the positioning mark 140 may be directly selected or selected after being pressed, which is determined according to the requirement of the designer.

Since the user interface 115 displayed in the handheld device 100 has no other press buttons except the function selection regions 110a, 110b, 110c and 110d and the execution region 120, and the execution region 120 is surrounded by the function selection regions 110a, 110b, 110c and 110d, the operation interface is very terse to enable a user to operate the user interface 115 intuitively.

In this embodiment, when the function selection region 110a is selected, the function selection region 110a, execution region 120 and the display region 130 can display a first background color (e.g., red). When the function selection region 110b is selected, the function selection region 110b, execution region 120 and the display region 130 can display a second background color (e.g., green). When the function selection region 110c is selected, the function selection region 110c, execution region 120 and the display region 130 can display a third background color (e.g., blue). When the function selection region 110d is selected, the function selection region 110d, execution region 120 and the display region 130 can display a fourth background color (e.g., orange). Such a design not only can make the user interface 115 have a beautiful and enchanting appearance, but also can enable the user to identify the function selection region selected currently only in accordance with the displayed color.

FIG. 3 is a front view of the execution region 120 shown in FIG. 2 after being pressed. Referring to both of FIGS. 1 and 3, when the execution region shown in FIG. 2 is pressed, the execution region 120 executes a function of the function selection region 110a (such as video recording) and sends a comment corresponding to the execution region 120 to the electronic device 200. After the electronic device 200 receives the comment from the execution region 120, the electronic device 200 feeds back second information to the handheld device 100. As a result, the display region 130 displays the second information fed back from the electronic device 200 to the handheld device 100 in accordance with the comment corresponding to the execution region 120. The second information is for example a used recording time, a rest available recording time. The electronic device 200 can detect the space of a hard disk or a memory of itself, and images output from the gaming device 400 to generate the second information. Additionally, when the user interface 115 is operated, synchronously the electronic device 200 can display the data of the display region 130 on the display 300 for convenience of viewing by the user.

Referring to both of FIGS. 2 and 3, in this embodiment, after the execution region 120 is pressed, the word “Video Record” of the execution region 120 is converted into a symbol representing video recording (see FIG. 3), and the patterns of the function selection regions 110a, 110b, 110c and 110d are converted into a light bar 110e related to the rest available video recording time. When the number of the light bar 110e is less, the rest storage space of the electronic device 200 is smaller, so that the user can determine whether the storage space is enough easily.

Returning to FIGS. 1 and 2, since the user interface 115 is displayed in the handheld device 100 and the handheld device 100 is electrically connected to the electronic device 200 the handheld device 100 can send the comment to the electronic device 200 through the user interface 115 and the electronic device 200 can feed back information to the handheld device 100 in accordance with the comment. After the handheld device 100 receives the information from the electronic device 200, the display region 130 of the handheld device 100 can display the information of the electronic device 200 corresponding to the execution region 120. As a result, the information displayed in the display region 130 of the user interface 115 can be updated synchronously with that of the electronic device 200 for convenience of monitoring by the user.

Additionally, the user interface 115 can be displayed on a screen of the handheld device 100, and the handheld device 100 may for example be a cell phone or a tablet computer, so that it does not require that the electronic device 200 should be provided with a conventional remote controller corresponding to the electronic device 200 during product shipping. It only requires providing an optical disk or network download point of the user interface 115 to be stored into the handheld device 100 by the user, such that the handheld device 100 can control the electronic device 200 through the user interface 115. Therefore, the manufacture cost of the conventional remote controller can be eliminated.

It is to be noted that the described connection relationships between the components will not be described again in the following description.

FIG. 4 is a front view of the function selection regions 110a, 110b, 110c and 110d shown in FIG. 2 after being dragged towards the direction D1. Referring to both of FIGS. 2 and 4, after the function selection region 110b is aligned with the positioning mark 140, the function selection region 110b is selected. The function selection region 110b is a video play selection button, so that the information displayed in the display region 130 will be converted from the first information related to video recording shown in FIG. 2 into another first information related to video playing (e.g., a name of the video, a display duration time and a file size). Additionally, the words in the execution region 120 are changed from “Video Record” to “Video Play”. Then after the execution region 120 is pressed, the function of the function selection region 110b can be performed, and the display region 130 can display the second information fed back from the electronic device 200 (see FIG. 1) to the handheld device 100 (see FIG. 1) in accordance with the comment corresponding to the execution region 120.

FIG. 5 is a front view of the function selection regions 110a, 110b, 110c and 110d shown in FIG. 4 after being dragged towards the direction D1. Referring to both of FIGS. 4 and 5, after the function selection region 110c is aligned with the positioning mark 140, the function selection region 110c is selected. The function selection region 110c is a setting selection button, so that the information displayed in the display region 130 is converted from the first information related to video playing shown in FIG. 4 to another first information related to setting (e.g., a signal source or a model number of a capture device). Additionally, the words in the execution region 120 are changed from “Video Play” to “Setting”. Then after the execution region 120 is pressed, the function of the function selection region 110c can be performed, and the display region 130 can display the second information fed hack from the electronic device 200 (as see FIG. 1) to the handheld device 100 (see FIG. 1) in accordance with the comment corresponding to the execution region 120.

FIG. 6 is a front view of the function selection regions 110a, 110b, 110c and 110d shown in FIG. 5 after being dragged towards the direction D1. Referring to both of FIGS. 5 and 6, after the function selection region 110d is aligned with the positioning mark 140, the function selection region 110d is selected. The function selection region 110d is a video capture selection button, so that the information displayed in the display region 130 is converted from the first information related to setting shown in FIG. 5 to another first information related to snap shooting (e.g., a snapshot picture). Additionally, the words in the execution region 120 are changed from “Setting” to “Snap Shoot”. Then after the execution region 120 is pressed, the function of the function selection region 110d can be performed, and the display region 130 displays the second information fed back from the electronic device 200 (see FIG. 1) to the handheld device 100 (see FIG. 1) in accordance with the comment corresponding to the execution region 120.

FIG. 7 is a front view of a user interface 115 displayed in the handheld device 100′ according to another embodiment of the present invention. The difference of the embodiment shown in FIG. 7 from that shown in FIG. 2 is that the handheld device 100′ is a tablet computer and the user interface 115 has a function selection region 110f which replaces the function selection region 110c shown in FIG. 2. The function selection region 110f is a network streaming selection button.

In this embodiment, the handheld device 100′ is a tablet computer and thus has a large display region 130. When the function selection region 110a is aligned with the positioning mark 140, the display region 130 can display more first information. For example, the display region 130 can synchronously display, but not limited to the gaming image displayed in the display 300 (see FIG. 1).

FIG. 8 is a front view of the function selection regions 110a, 110b, 110c, 110d and 110f shown in FIG. 7 after being dragged towards a direction D2. Referring to both of FIGS. 7 and 8, after the function selection region 110f is aligned with the positioning mark 140, the function selection region 110f is selected. The function selection region 110f is a network streaming selection button, so that the information displayed in the display region 130 is converted from the first information related to video recording shown in FIG. 7 to another first information related to network streaming. Additionally, the words in the execution region 120 are changed from “Video Record” to “Streaming”. Then after the execution region 120 is pressed, the function of the function selection region 110f can be performed, and the display region 130 can display the second information fed back from the electronic device 200 (see FIG. 1) to the handheld device 100 (see FIG. 1) in accordance with the comment corresponding to the execution region 120.

FIG. 9 is a front view of the function selection regions 110a, 110b, 110c, 110d and 110f shown in FIG. 8 after being dragged towards the direction D2. After the function selection region 110d is aligned with the positioning mark 140, the function selection region 110d is selected. Compared with the embodiment of FIG. 6, in this embodiment the display region 130 of the handheld device 100′ can display more first information. For example, the display region 130 can synchronously display the gaming image displayed in the display 300 (see FIG. 1), and also display a snapshot picture size and a preview of the snapshot picture, but the information displayed in the display region 130 is not limited to these.

FIG. 10 is a front view of the function selection regions 110a, 110b, 110e, 110d and 110f shown in FIG. 9 after being dragged towards the direction D2. After the function selection region 110b is aligned with the positioning mark 140, the function selection region 110b is selected. Compared with the embodiment shown in FIG. 4, in this embodiment the display region 130 of the handheld device 100′ can display more first information. For example, the display region 130 can synchronously display the gaming image displayed in the display 300 (as shown in FIG. 1), and also display a name, length and size of a file, but the present invention is not limited in this regard.

FIG. 11 is a flow chart of an operation method of a control system according to an embodiment of the present invention. First in step S1, providing a handheld device having a user interface and an electronic device electrically connected to the handheld device. Then in step S2, selecting at least one function selection region of the user interface is selected, such that a display region of the handheld device displays first information of the electronic device corresponding to the selected function selection region. Thereafter in step S3, pressing an execution region of the user interface, wherein the execution region is surrounded by the function selection region. Subsequently in step S4, sending a comment corresponding to the execution region to the electronic device, and feeding back second information from the electronic device to the handheld device in accordance with the comment. Afterwards in step S5, displaying the second information in the display region.

Additionally, the step S2 may include pressing the function selection region of the user interface, such that the function selection region is selected. When the number of the function selection regions is plural, the step S2 may include: dragging the function selection regions towards a direction, such that the function selection regions rotate around the execution region; and then stopping to drag the function selection regions, such that one of the function selection regions aligned to a positioning mark is selected.

The readers attention is directed to all papers and documents which are filed concurrently with this specification and which are open to public inspection with this specification, and the contents of all such papers and documents are incorporated herein by reference.

All the features disclosed in this specification (including any accompanying claims, abstract, and drawings) may be replaced by alternative features serving the same, equivalent or similar purpose, unless expressly stated otherwise. Thus, unless expressly stated otherwise, each feature disclosed is one example only of a generic series of equivalent or similar feature.

What is claimed is:

1. A user interface displayed in a handheld device for controlling an electronic device electrically connected to the handheld device, comprising:
at least one function selection region;
an execution region surrounded by the function selection region for executing a function of the function selection regions and sending a comment corresponding to the execution region to the electronic device; and
a display region, wherein when the function selection region is selected, the display region is for displaying first information of the electronic device corresponding to the function selection region; and when the execution region is pressed, the display region is for displaying second information fed back from the electronic device to the handheld device in accordance with the comment.

2. The user interface of claim 1, wherein the number of the function selection regions is plural, and the user interface further comprises:
a positioning mark disposed at an inner edge or outer edge of the function selection regions.

3. The user interface of claim 1, wherein an outer edge of the execution region is adjacent to an inner edge of the function selection region.

4. The user interface of claim 1, wherein the function selection region is a video recording selection button, network streaming selection button, video play selection button, video capture selection button or setting selection button.

5. The user interface of claim 1, wherein the number of the function selection regions is plural, and when one of the function selection regions is selected, the selected function selection region, the execution region and the display region display a first background color; and when another one of the function selection regions is selected, the selected function selection region, the execution region and the display region display a second background color different from the first background color.

6. A control system comprising:
an electronic device; and
a handheld device electrically connected to the electronic device, wherein the handheld device has a user interface, and the user interface comprises:
at least one function selection region;
an execution region surrounded by the function selection region for executing a function of the function selection regions and sending a comment corresponding to the execution region to the electronic device; and
a display region, wherein when the function selection region is selected, the display region is for displaying first information of the electronic device corresponding to the function selection region; and when the execution region is pressed, the display region is for displaying second information fed back from the electronic device to the handheld device in accordance with the comment.

7. The control system of claim 6, wherein the electronic device comprises a video recording unit, a network stream unit, a video display unit, a video capture unit or combinations thereof.

8. An operation method of a control system comprising the steps of:
(a) providing a handheld device having a user interface and an electronic device electrically connected to the handheld device;
(b) selecting at least one function selection region of the user interface, such that a display region of the handheld device displays first information of the electronic device corresponding to the function selection region;
(c) pressing an execution region of the user interface, wherein the execution region is surrounded by the function selection region;
(d) sending a comment corresponding to the execution region to the electronic device, and feeding back second information from the electronic device to the handheld device in accordance with the comment; and
(e) displaying the second information in the display region.

9. The operation method of the control system of claim 8, wherein the step (b) comprises:
pressing the function selection region of the user interface, such that the function selection region is selected.

10. The operation method of the control system of claim 8, wherein the number of the function selection regions is plural, and the step (b) comprises:
dragging the function selection regions towards a direction, such that the function selection regions rotate around the execution region; and
stopping to drag the function selection regions, such that one of the function selection regions aligned to a positioning mark is selected.
